(19) United States
(12) Patent Application Publication
(10) Pub. No.: US 2014/0354812 A1
(43) Pub. Date: Dec. 4, 2014

(54) Headrest-Supported Vehicle Monitoring System

(71) Applicant: Theresa Schafer, Rosedale, MD (US)

(72) Inventor: Theresa Schafer, Rosedale, MD (US)

(21) Appl. No.: 14/294,938

(22) Filed: Jun. 3, 2014

Related U.S. Application Data
(60) Provisional application No. 61/956,131, filed on Jun. 3, 2013.

(51) Int. Cl. B60R 11/02

(52) U.S. Cl. CPC B60R 11/0211
USPC 348/148

(57) ABSTRACT

A means for a driver to monitor the back seat of an automobile without having to physically turnaround is provided. The present invention comprises a camera, a camera holder that is removably mountable to an automobile car seat headrest, a video monitor, a monitor holder that is removably mountable to an automobile air vent, and a means of wirelessly transmitting video captured by the camera to the monitor for viewing thereon. The present invention is adapted to provide individuals who are driving with the ability to watch their children who are secured in rearward-facing car seats without having to physically turn around and take their eyes off of the road. The present invention thereby provides drivers with peace of mind and increases road safety.

### CROSS REFERENCE TO RELATED APPLICATION

This application claims the benefit of U.S. Provisional Application No. 61/956,131 filed on June 3, 2013. The above identified patent application is herein incorporated by reference in its entirety to provide continuity of disclosure.

### BACKGROUND OF THE INVENTION

### Field of the Invention

The present invention relates to in-automobile monitoring systems. More specifically, the present invention relates to monitoring systems that have a headrest-mountable camera.

Drivers often become distracted when driving an automobile when they have babies or other young children in the back seat of their vehicle, which can be extremely dangerous. Some drivers find it difficult to concentrate on the task of driving when they are constantly worrying about whether their children in the back seat are behaving. Other drivers grow distracted when they have a baby held within a rearward facing car seat in the back seat of the automobile, because the driver cannot easily see the baby's face. Therefore, the drivers often become increasingly concerned about whether the baby is safe and comfortable. In order to monitor either babies or children in the back seat of an automobile, drivers are generally forced to completely turn around, which removes their eyes from the road and puts everyone in the car in danger.

Baby or young child video monitoring systems are known in the prior art, but they are generally not adapted for use within an automobile. Furthermore, these systems are generally not freely positionable and thus cannot be used to monitor children of different ages, who may or may not be in car seats, from different positions. Therefore, there is a need in the prior art for a highly adjustable video monitoring system that is specifically adapted for use within an automobile.

An in-vehicle video monitoring system is provided. The present invention comprises a camera, a camera holder that is adapted to be removably secured to a vehicle's headrest, a video monitor, a video monitor mount that is adapted to be removably affixed to a vehicle's air vents, and a means of streaming video from the camera to the video monitor so that it is viewable thereon. The positions of both the camera and the video monitor are freely adjustable so that users can customize both the direction the camera is pointed at and the location of the video monitor so that its screen can be watched, but it is not distracting the user while he or she drives. The present invention thereby provides a highly customizable and convenient means for monitoring babies and young children in the back seat of an automobile in a safe manner.

### DESCRIPTION OF THE PRIOR ART

Devices have been disclosed in the prior art that relate to video monitoring systems. These include devices that have been patented and published in patent application publications. These devices generally relate to cameras or audio recording devices that may be placed in one location and wirelessly transmit the video or audio data for a receiving unit. The following is a list of devices deemed most relevant to the present disclosure, which are herein described for the purposes of highlighting and differentiating the unique aspects of the present invention, and further highlighting the drawbacks existing in the prior art.

Several different types of baby and young child video monitoring systems are known in the prior art; however, none of these systems are specifically adapted for use within a vehicle, utilize a headrest-mountable camera, and utilize a vehicle air vent-mountable receiving unit for viewing video streamed from the camera. The present invention thereby provides users a novel means for safely monitoring the activities of babies and young children in the back seat of an automobile that is being driven. The present invention enhances roadway safety and gives users peace of mind that their children are comfortable, safe, and behaving properly.

The present invention substantially diverges in design elements from the prior art and consequently it is clear that there is a need in the art for an improvement to existing child video monitoring devices. In this regard the instant invention substantially fulfills these needs.

### SUMMARY OF THE INVENTION

In view of the foregoing disadvantages inherent in the known types of video monitoring devices now present in the prior art, the present invention provides a new in-vehicle, headrest mountable video monitoring system wherein the same can be utilized for providing convenience for the user when monitoring the activities of babies or other young children in the back seat of a automobile.

It is therefore an object of the present invention to provide a new and improved in-vehicle video monitoring system that has all of the advantages of the prior art and none of the disadvantages.

It is another object of the present invention to provide an in-vehicle video monitoring system that is freely adjustable.

Another object of the present invention is to provide an in-vehicle video monitoring system that wirelessly streams video from a camera to a video monitor receiving unit.

Another object of the present invention is to provide an in-vehicle video monitoring system that is adapted to allow drivers to monitor babies held within a rearward-facing car seat positioned in the back seat of an automobile without having to physically turn around.

Yet another object of the present invention is to provide an in-vehicle video monitoring system that is adapted to allow drivers to monitor children seated in the back seat of an automobile without having to physical turn around.

Yet another object of the present invention is to provide an in-vehicle video monitoring system wherein the video-capturing camera and the video-receiving monitor unit are freely positionable.

Still yet another object of the present invention is to provide an in-vehicle video monitoring system wherein the video-capturing camera is removably affixed to a headrest.

Still yet another object of the present invention is to provide an in-vehicle video monitoring system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the various components of the present invention.

FIG. 2 shows a perspective view of the camera component of the present invention mounted to an automobile headrest.

FIG. 3A shows a perspective view of the monitor component of the present invention mounted to an automobile air vent.

FIG. 3B shows a close up view of the monitor vent clip mounted to an automobile air vent.

### DETAILED DESCRIPTION OF THE INVENTION

Reference is made herein to the attached drawings. Like reference numerals are used throughout the drawings to depict like or similar elements of the car seat monitoring system. For the purposes of presenting a brief and clear description of the present invention, the preferred embodiment will be discussed as used for monitoring a baby resting in a rearward-facing car seat. The figures are intended for representative purposes only and should not be considered to be limiting in any respect.

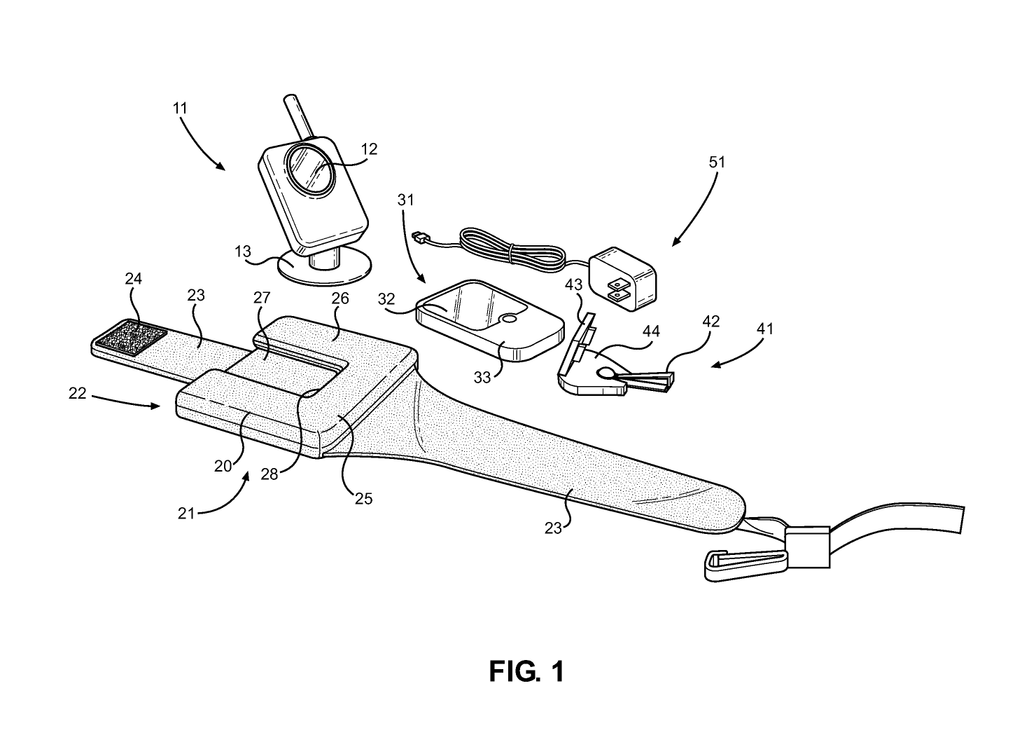

Referring now to FIG. 1, there is shown a perspective view of the various components of the present invention. The present invention is designed to provide drivers with the ability to monitor children in the backseat of their car, without having to physically turn their head or body and take their eyes off of the road. The present invention is useful for monitoring children of all ages, including babies in a rearward-facing car seat. The present invention comprises a camera 11, a camera holder 21, a video monitor 31, and a video monitor mount 41. The camera 11 comprises any means for capturing video as is known in the prior art, a base 13 that is slidably insertable into the camera holder 21, and a wireless transceiver for transmitting the captured video data to the video monitor 31. The camera 11 is wirelessly connectable to the video monitor 31 via any means known in the prior art, including Bluetooth and other such wireless connections. In the depicted embodiment of the present invention, the camera 11 captures video via a lens 12 that is disposed on the front portion of the camera 11 housing. The camera 11 is adjustably connected to the base 13 so that the direction from which the camera 11 can capture video is alterable by the user. The connection between the camera 11 and the base 13 comprises any adjustable connection known in the prior art, including a ball-and-socket joint. The camera 11 and the video monitor 31 further comprise a power source, such as batteries or a power source that is rechargeable via an electrical adapter 51. The adapter 51 comprises a USB adapter, an adapter for a conventional electrical outlet, or an adapter that is adapted to engage with an automobile cigarette lighter.

The camera holder 21 is adapted to removably mount the camera 11 to an automobile headrest and hold the camera 11 in place to provide a steady video image that is transmitted to the video monitor 31. The camera holder 21 comprises a pocket 22 adapted to hold the base 13 of the camera 11, a straps 23 extending from the pocket 22, and a removable fastener 24 disposed on the ends of the straps 23. The camera holder 21 comprises a receiving portion 28 that is adapted to receive and hold the camera base 13. In the depicted embodiment of the present invention, the pocket 22 has a bottom portion 25 and two side portions 26 that form a substantially U-shaped receiving portion 28, which is adapted to hold the camera base 13 in place against a rigid backing 27 extending along the back portion of the camera holder 21. The receiving portion 28 is adapted to securely hold the camera 11 in place, while still leaving the camera lens 12 free and unobstructed to record video. The camera base 13 is insertable into the pocket 22 via an opening at the top portion of the pocket 22. In the depicted embodiment of the present invention, the bottom 25 and side portions 26 of the present invention hold three of the sides of the camera base 13, thereby holding the camera 11 in place when inserted through the open top end. In an alternative embodiment of the present invention, the bottom portion is not a single contiguous piece, but is instead two separate pieces that are removable joinable together via a fastener, such as hook-and-loop material. This embodiment of the present invention further comprises a parallel top portion, which may also comprise two separate pieces joined together via a fastener, in order to secure all four sides of the camera base 13.

The video monitor 31 comprises a screen 32 for displaying video data transmitted thereto from the camera 11 and a wireless transceiver for receiving said transmitted video data. The screen 32 comprises any video display known in the prior art, such as an LCD display. The video monitor mount 41 comprises a body 44 having a front surface with a connector 43 disposed thereon and a back surface having a vent clip 42 disposed thereon. The video monitor 31 is mountable to the monitor mount 41 via the connector 43 disposed on the monitor mount 41 that engages with a complementary portion disposed on the video monitor 31. The connector 43 securely, but removably, affixes the video monitor 31 and to monitor mount 41 so that the video monitor 31 can be securely held in place before the user when the user is driving.

The vent clip 42 of the monitor mount 41 comprises a spring-loaded clip that is adapted to be affixed to an automobile's air vent. The vent clip 42 is removably attachable to any of the individual pivoting members that make up an automobile air vent. The monitor mount 41 is preferably rotatably connected to the vent clip 42, thereby providing the user with a means to freely adjust the position of the video monitor 32 as necessary.

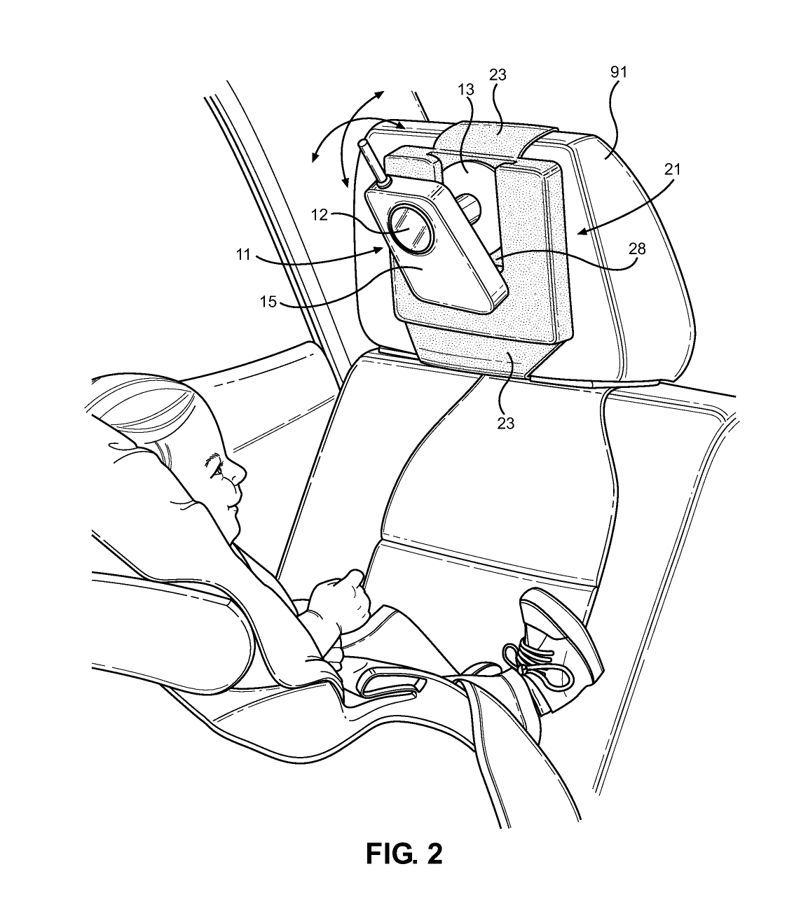

Referring now to FIG. 2, there is shown a perspective view of the camera component of the present invention mounted to an automobile headrest. The camera 11 is mountable to a vehicle headrest 91 via the camera holder 21, which comprises a receiving portion 28 adapted to receive the camera base 13 and at least one strap 23 that is securable around the vehicle headrest 91. In the depicted embodiment of the present invention, the strap 23 of the camera holder 21 is secured vertically around the vehicle headrest 91, through the headrest pegs, and back around so that opposing ends of the strap 23 may be fastened together. In an alternative embodiment of the present invention, the camera holder 21 instead utilizes straps extending from the sides of the device, rather than the top and the bottom, which extend horizontally around the vehicle headrest 91.

The camera holder 21, and the camera 11 supported therein, may either be attached to the front or the rear sides of a vehicle headrest 91, depending upon which viewing angle that the user desires. For example, if the user wishes to monitor a baby held within a rearward facing car seat in the backseat of the automobile, then he or she may attach the camera holder to the front surface of the headrest 91 for the rear seat. The camera 11 will therefore be positioned so that it is facing forward, towards the baby in the car seat. This configuration is especially beneficial because drivers generally cannot see the face of babies held within a rearward facing car seat in the back seat of an automobile without physically turning around and contorting their bodies, which is exceptionally dangerous when driving. Alternatively, the use can affix the camera holder 21 to the rear surface of one of the front seat headrests 91, positioning the camera 11 so that it is facing towards the rear portion of the automobile and thereby providing the driver with a means to watch children in the backseat of the automobile without having to turn around. The present invention improves drivers' roadway safety by providing drivers with a means to monitor babies and other children in the back seat of the automobile, without having to actually physical turn around.

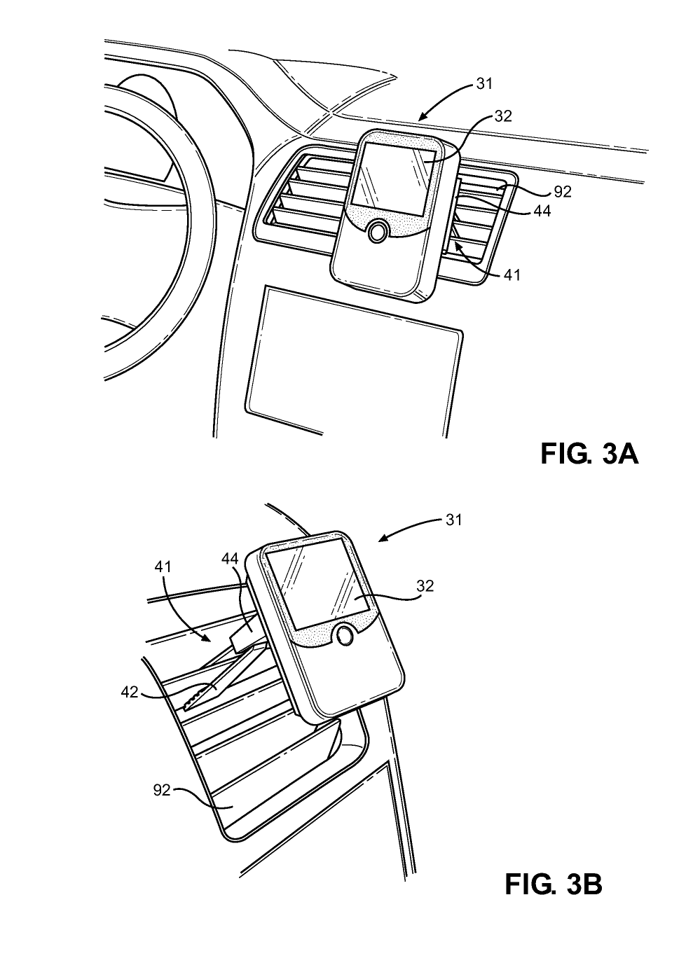

Referring now to FIGS. 3A and 3B, there are shown a perspective view of the video monitor component of the present invention mounted to an automobile air vent and a close up view of the monitor vent clip mounted to an automobile air vent. The video monitor 31 comprises a screen 32 and a means for wirelessly receiving streaming video data transmitted from the camera 11. The video monitor 31 is removably securable to the monitor mount 41, which in turn is removably mountable to a vehicle's air vents 92. The monitor mount 41 comprises a connector 43 that secures the video monitor 31 to the monitor mount 41, a vent clip 42, and a body portion 44 that is adapted to support the video monitor 31. In one embodiment of the present invention, the body 44 is adjustably connected to the vent clip 42 such that the body 44 and the video monitor 31 connected thereto can freely rotate in a 360-degree direction about the vent clip 42. The video monitor 31 is thereby freely positionable so that the user can configure the video monitor 31 so that he or she can view the video monitor 31 without having to take his or her eyes off the road. The present invention thereby provides users with a means to watch streaming video data captured from the camera 11, without having to take their eyes off of the road.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A video monitoring system, comprising:
a video camera having a housing, a lens, and a wireless transceiver;
a video camera holder adapted to removably secure said video camera;
wherein said video camera holder is adapted to be removably affixed to a vehicle headrest;
a video monitor having a housing, a screen, and a wireless transceiver;
wherein said video camera wireless transceiver is adapted to transmit video and said monitor wireless transceiver is adapted to receive said video for viewing on said monitor in real-time;
a video monitor mount having a body, a connector that is removably securable to said video monitor, and an air vent clip that is removably securable to a vehicle air vent.

2. The video monitoring system of claim 1, wherein said video camera holder comprises a pocket adapted to receive said video camera and a strap that is adapted to be secured around a vehicle headrest.

3. The video monitoring system of claim 1, further comprising:
a base extending from said video camera housing;
wherein said video camera holder comprises a pocket adapted to receive said video camera base and at least one strap that is adapted to be secured around a vehicle headrest.

4. The video monitoring system of claim 3, wherein said video camera is rotatably connected to said base.

5. The video monitoring system of claim 1, wherein said video monitor body is rotatably connected to said air vent clip.

6. The video monitoring system of claim 1, wherein said video camera further comprises a rechargeable power source.

7. The video monitoring system of claim 1, wherein said video monitor further comprises a rechargeable power source.

8. The video monitoring system of claim 6, further comprising an electrical adapter adapted to recharge said video camera power source.

9. The video monitoring system of claim 7, further comprising an electrical adapter adapted to recharge said video monitor power source.

10. The video monitoring system of claim 1, wherein said video camera holder comprises a U-shaped portion adapted to receive said video camera and a rigid backing adapted to hold said video camera in place.

11. The video monitoring system of claim 3, wherein said video camera holder pocket comprises a U-shaped portion adapted to receive said video camera base and a rigid backing adapted to hold said video camera in place.
